(19) United States
(12) Patent Application Publication
(10) Pub. No.: US 2010/0006715 A1
(43) Pub. Date: Jan. 14, 2010

(54) FLOOR STANDING SUPPORT FOR AN LCD OR PLASMA DISPLAY

(75) Inventors: Andrew Wills, East Dulwich (GB); Seiyo Ezure, Woking (GB); Alex Lau, Barnes (GB)

Correspondence Address: CARTER, DELUCA, FARRELL & SCHMIDT, LLP, 445 BROAD HOLLOW ROAD, SUITE 420, MELVILLE, NY, 11747, US

(73) Assignee: Colebrook Bosson Saunders Products Ltd., London (GB)

(21) Appl. No.: 12/447,066

(22) PCT Filed: Oct. 24, 2007
(86) PCT No.: PCT/EP07/61441

§ 371 Date: Sep. 15, 2009

(30) Foreign Application Priority Data
Oct. 24, 2006 (GB) 0621144.5

(51) Int. Cl. F16M 11/04; F16M 11/22

(52) U.S. Cl. 248/121; 248/163.1; 248/440.1

(57) ABSTRACT

A floor-standing support (1) for an LCD or plasma display (2) comprising a pair of upright display support members (13, 16) coupled together in spaced relation and, at least one interchangeable, non-load bearing decorative panel (12) extending between the display support members.

The invention relates to a floor-standing support for an LCD or plasma display.

Flat screen displays, for example LCD or plasma displays, are now in widespread use and are commonly used for display purposes, such as for advertising and for displays at exhibitions. They have the advantage of being relatively light and slim with a wide viewing angle. However, their slim footprint means that they are generally unable to stand unaided and so require a means to hold them in a stable upright position. Conventionally, such means comprise a basic stand for placement on a horizontal surface, for example a work surface or table. Alternatively, a bracket may be attached to allow the display to be mounted directly on a vertical surface, such as a wall or partition.

A problem with the known arrangements mentioned above is that they may be unsuitable in certain situations, such as temporary exhibitions, in which there may be no suitable horizontal surface available on which to place a flat panel display having a basic stand, or no wall or vertical partition which is strong enough or suitable to secure the flat panel display directly thereto. Furthermore, many known flat panel display stands are unattractive and so detract from the overall appearance of the exhibition stand or office in which they are located.

The present invention seeks to provide a support for a flat panel display that overcomes or substantially alleviates some of the known problems with conventional flat panel display supports.

According to the present invention, there is provided a floor-standing support for an LCD or plasma display comprising a pair of upright display support members coupled together in spaced relation and, at least one interchangeable, non-load bearing decorative panel extending between the display support members.

Preferably, a mounting member extends between the upright display support members to receive an LCD or plasma display.

In one embodiment, the floor-standing support is configured so that, when an LCD or plasma display is attached to the mounting member, the decorative panel extends below the display and is visible to persons watching the display.

The decorative panel may extend from behind the display towards the floor.

Conveniently, said decorative panel is a front decorative panel, and a rear decorative panel extends between the display support members parallel to and spaced from the front decorative panel.

In a preferred embodiment, the tear decorative panel extends behind the mounting member and an LCD or plasma display attached thereto.

In an alternative embodiment, the pair of support members and the front and rear decorative panels together define a housing to receive wiring and/or electrical components.

Preferably, at least one decorative panel is lockable to the support members.

Preferably, the floor-standing support comprises a base, the display support members upstanding from the base.

The base may extend from the display support members beneath an LCD or plasma display attached to the mounting member.

In one embodiment, the floor-standing support for an LCD or plasma display further comprises a plurality of wheels mounted to the base.

Preferably, the floor-standing support for an LCD or plasma display includes means for mounting the upright display support members to a wall for rotation relative to the wall about a substantially vertical axis, one upright display support member comprising a leg extending from its lower end coaxial with said axis for rotation about said axis together with the display support members and, a foot to support the display support members coupled to the end of the leg that tests on the floor so that it remains stationary during rotation of the leg and display support members relative to the axis, a second leg depending from the other display support member remote from the axis and having a wheel attached thereto at its lower end in contact with the floor to guide movement of the display support members as they pivot about said axis towards and away from the wall.

The mounting means may comprise at least two hinges attached to one upright display support member.

Preferably, at least one cross-brace extends between each support member perpendicular thereto.

In one embodiment, the mounting member includes a cross-brace.

Preferably, the mounting member includes means to enable an LCD or plasma display to pivot relative to the support about a substantially horizontal axis.

Conveniently, at least one shelf is mountable to the display support members.

In another aspect of the invention, there is provided a floor-standing support for an LCD or plasma display comprising a pair of upright display support members coupled together in spaced relation and means for mounting the upright display support members to a wall for rotation relative to the wall about a substantially vertical axis, one upright display support member comprising a first leg extending from its lower end coaxial with said axis for rotation about said axis together with the display support members and, a foot to support the display support members coupled to the end of the first leg that rests on the floor so that it remains stationary during rotation of the first leg and display support members relative to the axis, a second leg depending from the other display support member remote from the axis and having a wheel attached thereto at its lower end in contact with the floor to guide movement of the display support members as they pivot about said axis towards and away from the wall.

Embodiments of the present invention will now be described, by way of example only, with reference to the accompanying drawing, in which:

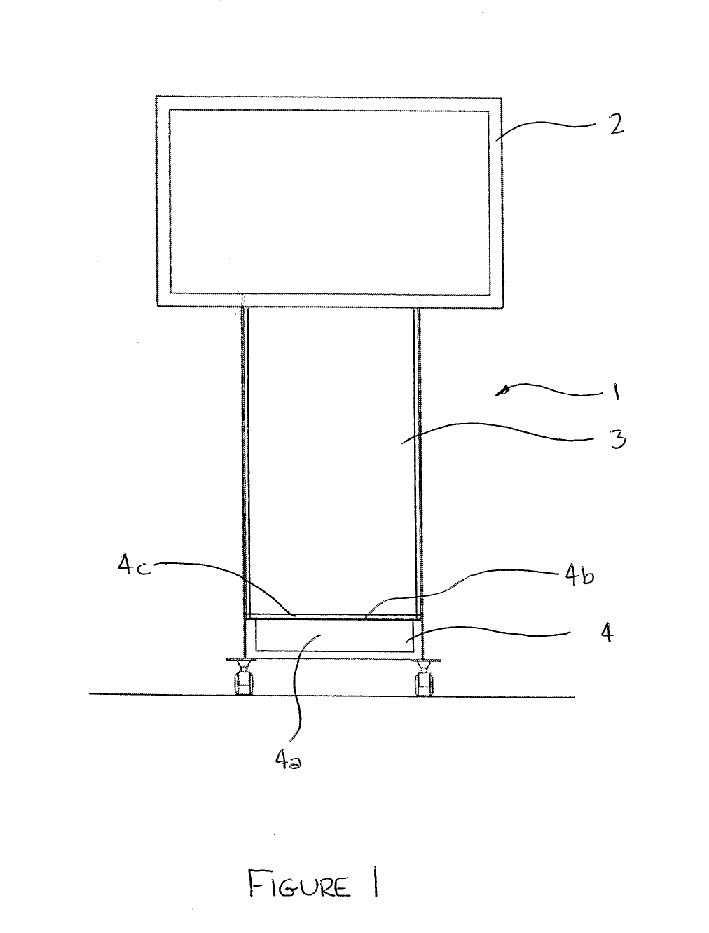

FIG. 1 is a front view of a support in accordance with an embodiment of the present invention with an LCD or plasma display secured thereto;

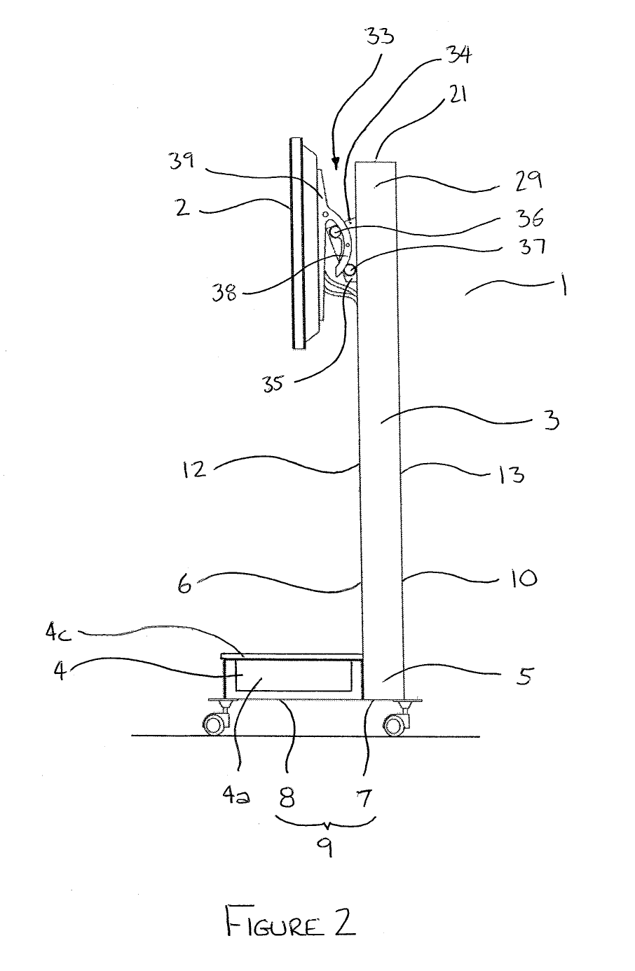

FIG. 2 is a side view of the support shown in FIG. 1;

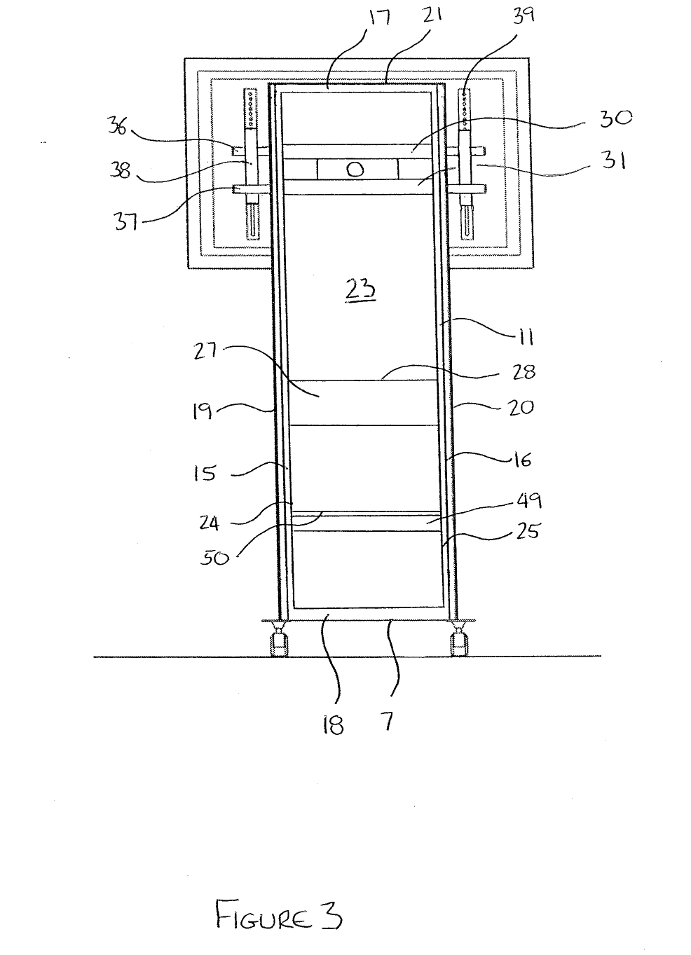

FIG. 3 is a rear view of the support as shown in FIG. 1 with a rear panel removed;

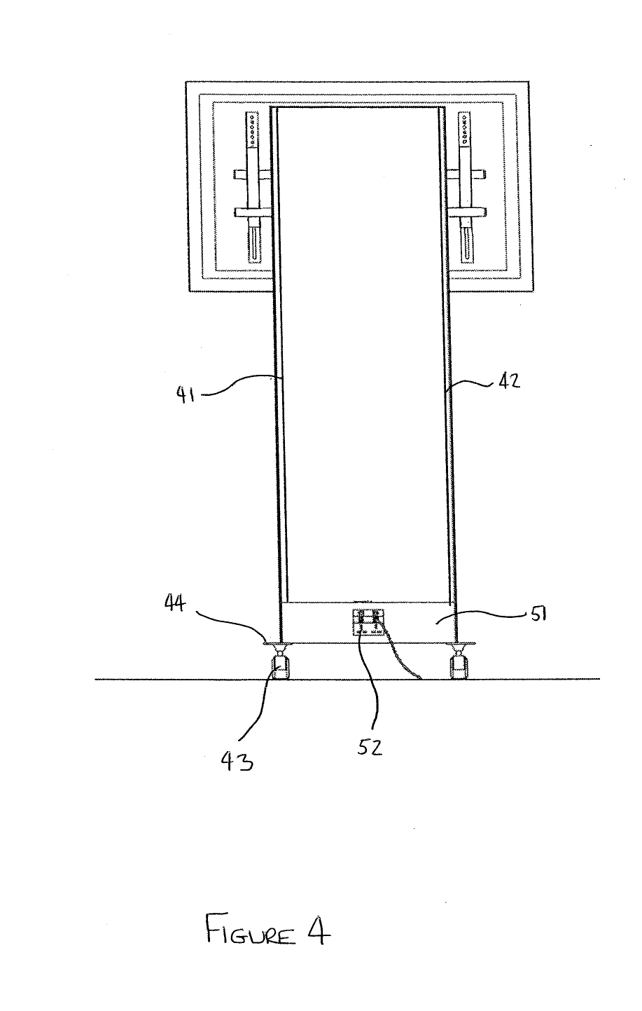

FIG. 4 is a rear view of the support as shown in FIG. 1 with the rear panel in place;

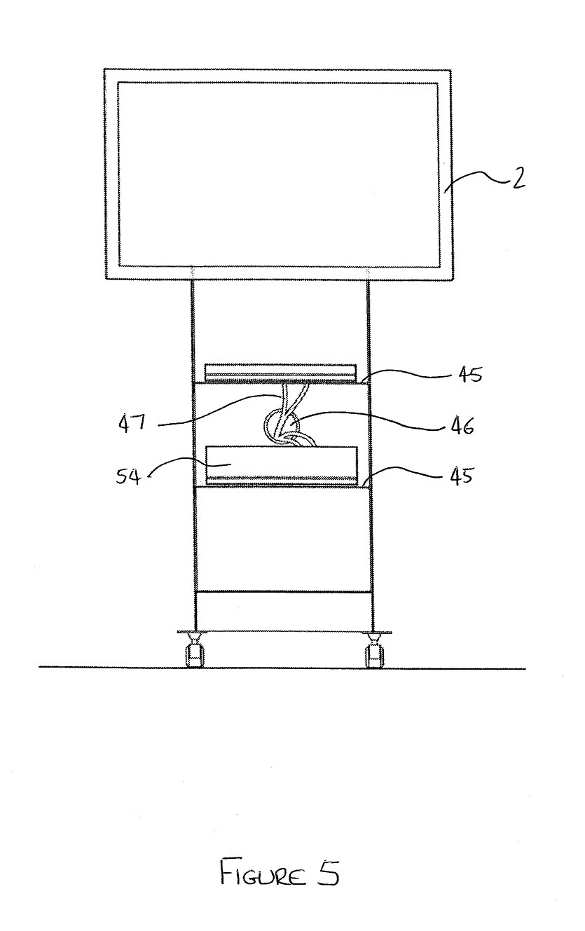

FIG. 5 is a front view of the support shown in FIG. 1 with a pair of external shelves mounted thereto;

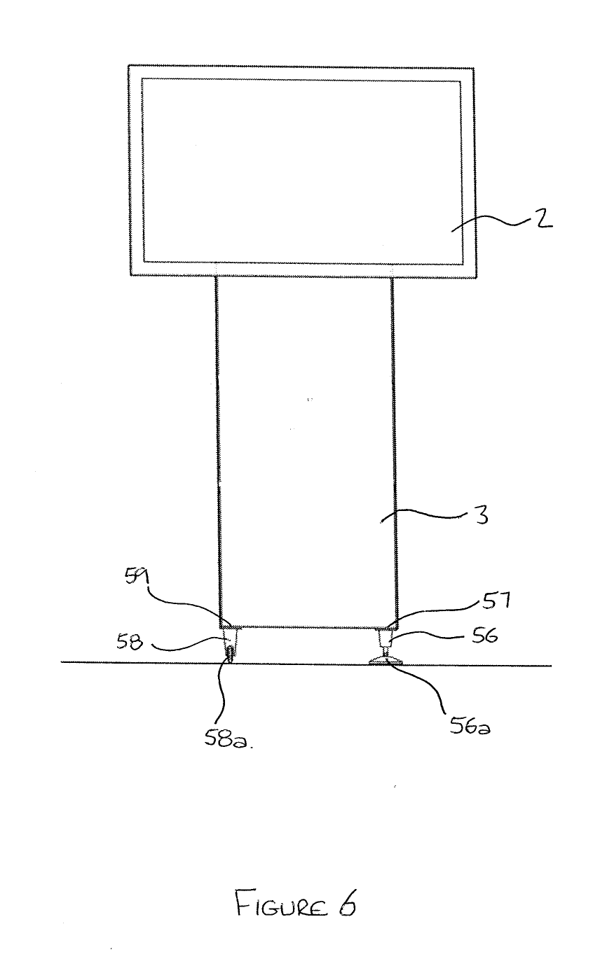

FIG. 6 is a front view of a support in accordance with another embodiment of the present invention with an LCD or plasma display secured thereto;

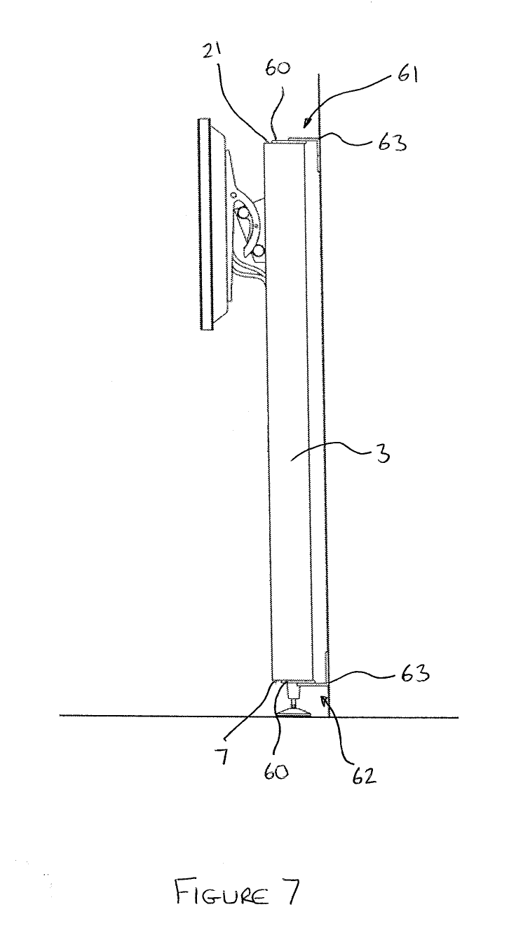

FIG. 7 is a side view of the support shown in FIG. 6;

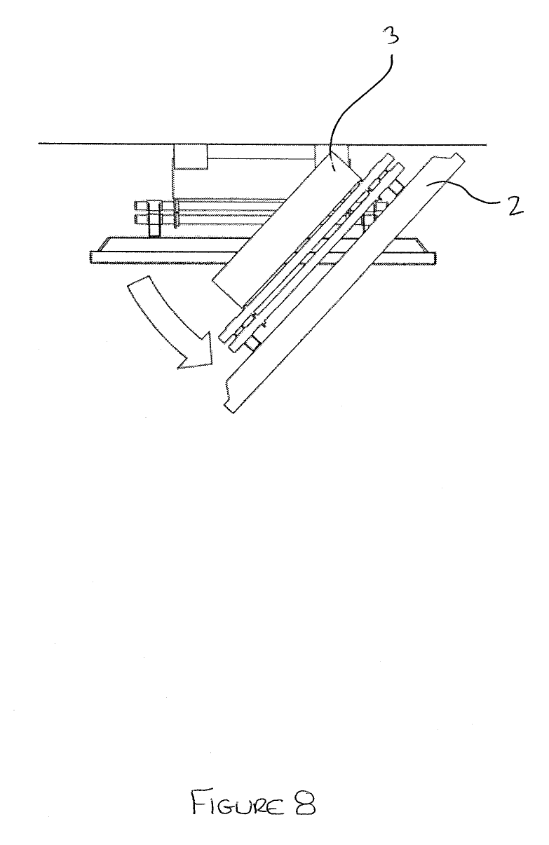

FIG. 8 is a plan view from above of the support shown in FIG. 6 showing rotation of the support about a vertical axis.

Referring now to the drawings there is shown in FIGS. 1 and 2 a support unit 1 according to an embodiment of the present invention, with a flat panel display 2 mounted thereto. The flat panel display 2 is conventional and is an LCD monitor, a plasma display, or the like. The support unit 1 comprises an upright longitudinal body 3 secured to a base portion 4 proximate a lower end 5 of the body 3. The base portion 4 extends perpendicularly from a front face 6 of the body 3. The base portion 4 is mounted to the front face 6 of the body 3 by known means, for example, bolts extending therebetween and fastened by nuts, such that a lower face 8 of the base portion 4 lies parallel to a lower end surface 7 of the body 3 to form an underside surface 9.

It will be appreciated that as the base portion 4 extends perpendicularly from the front face 6 of the body 2, the offset load of the flat panel display 2 is supported and so the support unit 1 is stable when free standing.

In an alternative arrangement, however, the base portion 4 may have a recess (not shown) formed therein which corresponds to the dimensions of the lower end 5 of the body 3 such that the lower end 5 is insertable therein and supported by the base portion 4 which extends therearound. In a further arrangement, the base portion 4 may extend from a rear face 10 of the body 3 and be suitably weighted to compensate for the offset load of the flat panel display 2. Additionally, the base portion 4 may be substantially hollow such that a compartment 4a is formed therein, wherein the compartment 4a is accessible through an upper face 4b of the base portion 4 and a lid portion 4c is disposed to cover the compartment 4a. The lid portion 4c may be hingably attached to the base portion 4 so as to allow easy access to the compartment 4a and/or it may be lockable thereto by known means.

The body 3 comprises a frame 11, and front and rear panels 12, 13 mounted to the frame 11 to form the front and rear faces 6, 10 of the body 3 respectively. Referring now to FIG. 3, it can be seen that the frame 11 of the body 3 is formed from a pair of upright support members 15, 16 linked by top and bottom members 17, 18 respectively mounted at each end to form a rectangular frame section. It will be appreciated that the upright support members do not have to be linked by the top and bottom members 17, 18 and may be coupled by alternative means, for example, by the base portion 4, or other means as will be described later.

The outer faces of the upright support members 15, 16 and top and bottom members 17, 18 define the outer side surfaces 19, 20 and upper and lower ends surfaces 21, 7 of the body 3 respectively. Together with the front and rear panels 12, 13, the upright support members 15, 16 define a housing enclosing an internal space 23. The members 15, 16, 17, 18 may be formed from extruded aluminum or the like, and are formed together by known means. In alternative configurations, a plurality of slots (not shown) are formed in the front face 26 of each upright support member 15, 16, extend longitudinally along each upright support member 15, 16 in the direction of the main axis of each upright support member 15, 16 and a plurality of opposing slots (not shown) are formed in the inner surfaces 24, 25 of the upright support members 15, 16, for reasons which will become apparent later.

A cross-brace 27 is disposed between each upright support member 15, 16 which extends therebetween approximately at a midpoint therealong to strengthen the frame 11. The cross-brace 27 is provided with a flat upper section 28 on which secondary components (not shown) may be disposed, as will be explained hereinafter.

Proximate to an upper end 29 of the body, a pair of parallel, vertically spaced mounting members 30, 31 extend horizontally between the upright support members 15, 16. Each mounting member 30, 31 is secured to the inside surface 24, 25 of each upright support member 15, 16 by known means.

Referring to FIG. 2, the flat panel display 2 is attached to the mounting members 30, 31 by mounting means 33. The mounting means 33 comprises a mounting bracket 34 secured to the mounting members 30, 31 having a pair of bracket portions 35 extending forwardly therefrom, upper and lower horizontal guide rods 36, 37 and a pair of mounting plates 39, each having an arcuate guide arm 38 extending therefrom. The front panel 12 does not extend to the upper end 29 of the body 3 in order to allow the mounting bracket 34 to extend from the front of the body 3 unimpaired.

In an alternative arrangement, the mounting bracket 34 comprises hooks (not shown) extending therefrom such that they are insertable in corresponding slots formed in the front face 26 of the upright support members 15, 16. In this arrangement, the mounting bracket 34, and hence the flat panel display 2 mounted thereto is then supported by the hooks in corresponding slots. The front panel 12 extends proximate to upper end 29 of the body 3 as the mounting bracket 34 does not extend from the mounting members 30, 31 and so does not interfere with the front panel 12. However, a further aperture (not shown) is formed through the front panel 12 proximate to the cable connection point (not shown) of the flat display panel 2 to allow access to the internal space 23.

Each horizontal guide rod 36, 37 is mounted between the pair of bracket portions 35 and extends each side thereof, the upper guide rod 36 being disposed further forward away from the frame 11 than the lower guide rod 37. The mounting plates 39 for the arcuate guide arms 38 are each mounted to the rear of the flat panel display 2 by known means such that the arcuate guide arms 38 extend backwardly therefrom and arc downwards. The arcuate guide arms 38 are both slidably disposed between the upper and lower guide rods 36, 37 such that the guide rods 36, 37 support the load of the flat panel display 2 transferred through the arcuate guide arms 38. Alternatively, the arcuate guide arms 38 may be mounted to the support unit 1 and the guide rods 36, 37 mounted to the flat panel display 2. In both arrangements, the mounting means 33 enables the flat panel display 2 to tilt about a horizontal axis relative to the frame 11.

The front and rear panels 12, 13 are formed such that they are releasably mounted to the frame 11 by means of clips or the like (not shown), or they may be resilient such that longitudinal side edges 41, 42 of each panel 12, 13 are insertable into opposing slots (not shown) formed in the inner surface 24, 25 of the frame 11. Optionally, the front and rear panels 12, 13 may be mounted to the frame 11 by means of locking bolts (not shown), for reasons which will be explained in detail hereinafter. It will be appreciated that as the front and rear panels 12, 13 are releasably mounted, the internal space 23 can be accessed via the front and/or rear panel 12, 13.

The front and rear panels 12, 13 may be formed from a solid plate, or alternatively a lightweight flexible material stretched over a rectangular frame (not shown). If the flexible material panels are used then a zip mechanism (not shown) with two zippers meeting at a centre point may be disposed to run horizontally or vertically in the material to allow access to the internal space 23 of the support unit 1. The front and rear panels 12, 13 may be used for promotional or advertising functions or the like, and as they are removable they may be replaced if the promotion changes.

Alternatively, advertising or promotional material may simply be attached to the outer surface of the front and rear panels 12, 13.

Pivotable wheels 43, such as castors, are disposed on respective wheel mounting plates 44 which are mounted to the underside surface 9 at each corner thereof. The pivoting wheels 43 allow a user to easily manoeuvre the support unit 1 and hence the flat panel display 2 into a desired position. Although four pivoting wheels 43 are shown in FIGS. 1 to 4 to stably support the support unit 1 it will be understood that the invention is not limited thereto. Further, the support unit 1 may optionally be disposed with the underside surface 9 resting directly on a floor without the use of pivoting wheels 43.

In one arrangement, wherein slots are formed in the front face 26 of each upright support member 15, 16, shelves 45 are removably mounted to the front face 26 of the upright support members 15, 16, as shown in FIG. 5. Each shelf 45 is attached to the body 3 by means of hooks (not shown) extending from each shelf 45 and locatable in the corresponding slots (not shown) in the upright support members 15, 16. In such an embodiment, an aperture 46 is formed through the front panel 12 to allow power and signal cables 47 to be insertable therethrough to allow access to the internal space 23.

In a further arrangement, wherein the opposing plurality of slots (not shown) are formed in the inner surface of each upright support member 15, 16, internal shelf portions 49 comprising a T-shaped cross section and a horizontal upper surface 50 are disposed in the internal space between the upright support members 15, 16. Hooks (not shown) at each end of each internal shelf portion 49 are insertable in corresponding slots such that each internal shelf portion 49 is locatable in the internal space 23.

A connector panel 51 is shown in FIG. 4. This is disposed on the rear face 10 of the frame 11 proximate to the lower end 5 thereof. The connector panel 51 may be formed of a plastic or metal plate and is fixedly mounted to the frame 11 by known means. The connector panel 51 has a number of connector points 52 disposed thereon, for example plug sockets and power lead points, for reasons that will become apparent below.

Operation of the support unit 1 for a flat panel display 2 will now be described. The flat panel display 2 is mounted to a respective mounting plate 39 which is subsequently disposed on the support unit 1, as explained above. The front panel 12 is then mounted to the front of the frame 11 by one of the means discussed previously. The mounting bracket 34 is fixedly attached to the mounting members 30, 31, or alternatively, to the upright support members 15, 16. The flat panel display 2 is then tilted to a chosen angle relative to the support unit 1.

Secondary components 54, which provide visual and/or audio signals to the flat panel display 2, are then connected thereto by means of cables 47 or the like. The cables 47 are run from the rear of the flat panel display 2 over the front panel 12, or in alternative setups, through the further aperture or the opening formed by the zip mechanism (not shown) to access the internal space 23. If it is required to place the secondary components 54 on external shelves then one or more shelves 45 are attached to the support unit 1 by means of hooks inserted into the corresponding slots (not shown) and the secondary components 54 placed thereon. The secondary components 54 are then connected to the flat panel display 2 by means of the cables 47 extending from the internal space 23 through the aperture 46.

In the arrangement with soft material front and rear panels 12, 13 and a zip mechanism (not shown), the zip fasteners (not shown) are opened to form a hole in the respective panel 12, 13 to allow said cables 47 to extend therethrough. Alternatively, the secondary components 54 are placed in the internal space 23 on the upper surface 28, 50 of the internal shelf portions 49 or cross-brace 27, and cables 47 are connected to the secondary components 54. If the secondary components 54 comprise a DVD player or the like, then a relevant DVD is inserted therein. The rear panel 13 is then fixedly attached to the body 3. In an embodiment where the panels 12, 13 are lockable, the front and rear panels 12, 13 are locked by means of locking bolts or the like (not shown), such that unauthorised access to the internal space is prevented. This allows secondary components 54, which may be expensive electrical equipment to be secured therein. Additionally, by placing all the secondary components 54 in the support unit 1 the aesthetics of the support unit is much improved.

Power cables (not shown) and the like are then communicated between the secondary components 54 and the flat panel display 2 to inner connections (not shown) on the connector panel 51. Therefore, only a single power cable (not shown) is required to be run from the support unit 1 and the cables are maintained in a neat and safe arrangement as they are hidden from view.

As both the front and rear panels 12, 13 are removable, the front and rear panels 12, 13 may be replaced dependent on the desired promotion, advertisement or the like that is being promoted, or shown on the flat panel display 2. If required, the advertising material is attached to the front and rear panels 12, 13.

The support unit 1 is then maneuvered into the required position and the connector panel 51 connected to a power supply such that the flat panel display 2 and support unit 1 may be operated as desired.

A further embodiment of the floor-standing support 1 for a flat panel display 2 will now be described with reference to FIGS. 6 to 8. The body 3 of this embodiment of the invention is generally the same as the body 3 described above, however, in this embodiment a base portion 4 is not required and therefore the front panel 12 extends proximate to the bottom end 5 of the body 3.

In this embodiment, a first leg 56 is mounted proximate to one end 57 of the lower end surface 7 of the body 3 and extends therefrom. A foot 56a to support the support unit 1 is rotatably coupled to the end of the first leg 56 distal to the lower end surface 7, to rest on the floor so that it remains stationary. Similarly, a second leg 58 is mounted proximate to the end 59 of the lower end surface 7 of the body 3 distal to the first leg 56. The second leg 58 has a wheel 58a attached thereto at its end distal to the lower end surface 7, in contact with the floor, to guide movement of the support 1.

Upper and lower hinges 61, 62 are fixedly attached to the upper and lower ends 29, 5 proximate to one upright support member 15, 16. A first portion 60 of the upper and lower hinges 61, 62 is fixed to the upper and lower end surfaces 21, 7 of the body 3 so that a second portion 63 of each hinge 61, 62 is rotatable about a vertical axis coaxial with the axis of the pivot of the foot 56a. The second portion 63 comprises a L-shaped bracket with screw holes formed therethrough such that the lower and upper hinges 61, 62 are fixedly attachable to a wall or vertical surface to stably support the body 3 rotatably mounted thereto. Furthermore, the first leg 56 and second leg 58 support the majority of the load such that the wall does not have to carry the entire load of the flat panel display 2 and support unit 1. It will be understood that the support unit 1 may be rotatably mounted to the wall by other known means.

The first and second legs 56, 58 together with the pair of hinges 61, 62 are mounted such that they allow the support unit 1 to move in an arcuate manner about the vertical axis of the rotatable foot 56a when the support unit 1 is rotated thereabout relative to the wall, as is shown in FIG. 8. This enables the support unit 1 to be maneuvered into a desired viewing angle and to allow access to the rear panel 12 and/or internal space 23, for example to place secondary components 54 therein.

Operation of the support unit 1 according to the above embodiment will now be described. The support unit 1 of the above embodiment operates in a similar way to the operation of the earlier embodiment, however, in this embodiment the support unit 1 and hence the flat panel display 2 are located in a desired position by rotation of said support unit 1 about the vertical axis, relative to the wall to which it is mounted, as shown in FIG. 8. Access to the internal space 23 is obtained either by removal of the front panel 13 or by rotating the support unit 1 such that there is access to the rear panel 12, which may then be removed.

Although embodiments of the invention have been shown and described, it will be appreciated by those skilled in the art that these are preferred embodiments only and that changes may be made to the above exemplary embodiments that lie within the scope of the invention, as defined in the following claims.

1-19. (canceled)

20. A floor-standing support for an LCD or plasma display, comprising:
a pair of upright display support members coupled together in spaced relation;
an interchangeable, non-load bearing front decorative panel extending between the display support members; and
an interchangeable, non-load bearing rear decorative panel extending between the display support members parallel to and spaced from said front decorative panel, wherein the pair of support members and the front and rear decorative panels together define a housing to receive wiring and/or electrical components.

21. A floor-standing support according to claim 20, further comprising a mounting member extending between the upright display support members to receive an LCD or plasma display.

22. A floor-standing support according to claim 21, configured so that, when an LCD or plasma display is attached to the mounting member, the decorative panel extends below the display and is visible to persons watching the display.

23. A floor-standing support according to claim 22, wherein the decorative panel extends from behind the display towards the floor.

24. A floor-standing support according to claim 21, wherein the rear decorative panel extends behind the mounting member and an LCD or plasma display attached thereto.

25. A floor-standing support according to claim 20, wherein at least one decorative panel is lockable to the support members.

26. A floor-standing support according to claim 20, further comprising a base, the display support members upstanding from the base.

27. A floor-standing support according to claim 26, wherein the base extends from the display support members beneath an LCD or plasma display attached to the mounting member.

28. A floor-standing support according to claim 27, further comprising a plurality of wheels mounted to the base.

29. A floor-standing support according to claim 20, further comprising:
means for mounting the upright display support members to a wall for rotation relative to the wall about a substantially vertical axis, one upright display support member including a first leg extending from its lower end coaxial with said axis for rotation about said axis together with the display support members and, a foot to support the display support members coupled to the end of the first leg that rests on the floor so that it remains stationary during rotation of the first leg and display support members relative to the axis, a second leg depending from the other display support member remote from the axis and having a wheel attached thereto at its lower end in contact with the floor to guide movement of the display support members as they pivot about said axis towards and away from the wall.

30. A floor-standing support according to claim 29, wherein the mounting means comprises at least two hinges attached to one upright display support member.

31. A floor-standing support according to claim 20, wherein at least one cross-brace extends between each support member perpendicular thereto.

32. A floor-standing support according to claim 31, wherein the mounting member includes a cross-brace.

33. A floor-standing support according to claim 20, wherein the mounting member includes means to enable an LCD or plasma display to pivot relative to the support about a substantially horizontal axis.

34. A floor-standing support for an LCD or plasma display, comprising:
a pair of upright display support members coupled together in spaced relation and means for mounting the upright display support members to a wall for rotation relative to the wall about a substantially vertical axis; and
one upright display support member including:
a first leg extending from its lower end coaxial with said axis for rotation about said axis together with the display support members;
a foot to support the display support members coupled to the end of the first leg that rests on the floor so that it remains stationary during rotation of the first leg and display support members relative to the axis; and
a second leg depending from the other display support member remote from the axis and having a wheel attached thereto at its lower end in contact with the floor to guide movement of the display support members as they pivot about said axis towards and away from the wall.
